(19) United States
(12) Patent Application Publication
(10) Pub. No.: US 2020/0387693 A1
(43) Pub. Date: Dec. 10, 2020

(54) SYSTEMS AND METHODS FOR FACIAL RECOGNITION-BASED PARTICIPANT IDENTIFICATION AND MANAGEMENT IN MULTI-PARTICIPANT ACTIVITY

(71) Applicant: Gregg Donnenfeld, Roslyn, NY (US)

(72) Inventor: Gregg Donnenfeld, Roslyn, NY (US)

(21) Appl. No.: 16/433,447

(22) Filed: Jun. 6, 2019

(51) Int. Cl. G06K 9/00; A63D 5/00; G06F 16/51; G06F 16/583

(52) U.S. Cl. CPC G06K 9/00288; A63D 5/00; G06K 2009/00328; G06F 16/5854; G06F 16/51

(57) ABSTRACT

A system includes a memory and a processor in communication with the memory. The processor is configured to receive facial image data associated with each participant from a number of participants of a live, turn-based multi-participant activity. The processor is configured to receive an image of an active participant performing an action associated with a turn of the activity. The processor is configured to perform facial recognition analysis on the image with respect to the facial image data stored in the participant profile data structure associated with each participant. The processor is configured to identify the active participant as a participant from the number of participants when a result of the facial recognition analysis satisfies a criterion. The processor is configured to define a data set associated with the at least one action, and to store the data set in the participant profile data structure associated with the participant.

### BACKGROUND

The present disclosure relates generally to image-analytics and/or video-analytics, and in particular, to systems and methods for facial recognition-based participant identification and participation management in and of multi-participant activities.

Increases in the availability and capability of electronic devices such as cameras, tablets, smartphones, etc. have allowed some people to take pictures and/or capture video of their experiences. For example, the inclusion and improvement of cameras in smartphones, tablets, and/or other similar devices have led to increases in those devices being used to take pictures (e.g., photographic data, image data, etc.) and videos (e.g., video stream data).

In some instances, venues and/or events such as sporting events, concerts, rallies, graduations, and/or the like have cameras that can take pictures and/or video of those in attendance. In some known systems, facial recognition technology can be used to facilitate the process of identifying people in the pictures and/or video stream captured at these venues and/or events and some such systems can be configured to distribute and/or otherwise make available the pictures and/or video stream to the people identified therein. While such systems may aid a person (e.g., a user) in memorializing events and/or the like by capturing them in pictures and/or video, in some instances, it may be desirable to use the pictures and/or videos in contexts other than and/or in addition to memorializing events and/or sharing experiences.

Thus, a need exists for improved apparatus and methods for performing facial recognition analysis on one or more images to identify an active participant in a live, turn-based multi-participant activity and to define and store data associated with at least one action performed by the active participant.

### SUMMARY

In some embodiments, a system includes a memory and a processor in communication with the memory. The processor is configured to receive facial image data associated with each participant from a number of participants of a live, turn-based multi-participant activity. The facial image data associated with each participant from the number of participants is stored, in the memory, in a participant profile data structure associated with that participant. The processor is configured to receive at least one image of an active participant performing at least one action associated with a turn of the live, turn-based multi-participant activity. The processor is configured to perform facial recognition analysis on the at least one image with respect to the facial image data stored in the participant profile data structure associated with each participant. The processor is configured to identify the active participant as a participant from the number of participants when the facial recognition analysis with respect to the facial image data associated with the participant satisfies a criterion. The processor is configured to define a data set associated with the at least one action and to store the data set in the participant profile data structure associated with the participant.

### BRIEF DESCRIPTION OF THE DRAWINGS

FIG. 1 is a schematic illustration of a recognition and participation management system, according to an embodiment.

FIG. 2 is a schematic illustration of a host device included in the recognition and participation management system of FIG. 1, according to an embodiment.

FIG. 3 is a flowchart illustrating a method of using a recognition and participation management system, according to an embodiment.

### DETAILED DESCRIPTION

In some embodiments, a system includes a memory and a processor in communication with the memory. The processor is configured to receive facial image data associated with each participant from a number of participants of a live, turn-based multi-participant activity. The facial image data associated with each participant from the number of participants is stored, in the memory, in a participant profile data structure(s) associated with that participant. The processor is configured to receive at least one image of an active participant performing at least one action associated with a turn of the live, turn-based multi-participant activity. The processor is configured to perform facial recognition analysis on the at least one image with respect to the facial image data stored in the participant profile data structure(s) associated with each participant. The processor is configured to identify the active participant as a participant from the number of participants when the facial recognition analysis with respect to the facial image data associated with the participant satisfies a criterion. The processor is configured to define a data set associated with the at least one action and to store the data set in the participant profile data structure(s) associated with the participant.

In some implementations, a method includes receiving facial image data at a processor. The facial image data is associated with each participant from a number of participants of a live, turn-based multi-participant activity. The facial image data associated with each participant from the number of participants is stored in a participant profile data structure(s) associated with that participant from the number of participants. The participant profile data structure(s) associated with each participant is stored in a memory. The method includes receiving at least one image of an active participant performing at least one action associated with a turn of the live, turn-based multi-participant activity. The active participant is identified as a participant from the number of participants in response to a facial recognition analysis of the at least one image with respect to the facial image data stored in the participant profile data structure(s) associated with the participant from the number of participants satisfying a criterion. A data set associated with the at least one action associated with the turn is defined and the data set is stored in the participant profile data structure(s) associated with the participant.

In some embodiments, the systems and/or the methods described herein can be implemented to identify a person from a number of persons (also referred to as a “participant(s)”) performing one or more actions during a round or turn of a live, turn-based multi-participant activity. After identifying the participant (e.g., an “active participant”), the systems and/or methods can define data associated with the one more actions and can store the data in a participant profile data structure. In some instances, the systems and/or methods described herein can enable, allow, and/or facilitate the participants to take turns in an order different from an original, predetermined, and/or previously defined order otherwise associated with the live, turn-based multi-participant activity. Said another way, the systems and/or methods can enable, allow, and/or facilitate out-of-turn actions, participation, and/or play by the participants in the live, turn-based multi-participant activity. Said yet another way, the systems and/or methods can enable, allow, and/or facilitate asynchronous live participation of the live, turn-based multi-participant activity. In some instances, the live, turn-based multi-participant activity can include any suitable turn-based activity such as, for example, turn-based multi-player games and/or the like. More specifically, such a turn-based multi-player game can be, for example, bowling, darts, and/or the like.

As used in this specification, the singular forms “a,” “an” and “the” include plural referents unless the context clearly dictates otherwise. Thus, for example, the term “a device” is intended to mean a single device or a combination of devices, “a network” is intended to mean one or more networks, or a combination thereof.

As used herein, the term “participant(s)” refer(s) to a person, a user, or the like, that is involved in, taking part in, and/or otherwise participating in an activity. A participant can be known to a system associated with the activity (e.g., the participant can be registered and/or otherwise identified as a participant of the activity) and who has either performed one or more actions or is expected to perform one or more actions associated with the activity.

As used herein, the term “turn-based multi-participant activity” refers to any activity, in which each participant from a set of participants generally takes a turn and/or otherwise performs one or more actions in a predetermined and/or predefined order, such as an agreed to order and/or per one or more rules of the activity. In some instances, a turn-based multi-participant activity can be a live and/or otherwise non-virtual, turn-based multi-participant activity. For example, a live and/or otherwise non-virtual, turn-based multi-participant activity can be a turn-based multi-player game that is played live and/or otherwise played in a non-virtual environment.

As used herein, the terms “participant connection(s),” “activity connection(s),”—or simply, “connection(s)”—refer generally to any association and/or relationship of, between, or among participants, participant accounts, and/or the like, known to have participated in an activity and/or expected to participate in an activity such as a live, turn-based multi-participant activity, or the like. For example, in some instances, two people or participants can be “connected” when they or their user or participant accounts indicate they were and/or are participants in an activity such as a live, turn-based multi-participant activity, or the like.

As used herein, the terms “predetermined order,” “predefined order,” “initial order,” and/or the like, refer generally to an initial sequence by which individual participants in a multi-participant activity can take (or alternate) turns in engaging in the activity (e.g., by performing one or more acts or actions related to or for the sake of participating in and/or progressing the activity). For example, a predetermined order can be an initial sequence of participant activity engagement that can be established at the onset of the activity and that otherwise can be expected to remain in effect for an entire progression of the activity unless otherwise changed. Any of the systems and/or methods included herein can be configured to identify an active participant (e.g., using facial recognition) and to define and/or store data associated with one or more actions performed by the active participant, which in turn, can allow and/or enable turns and/or actions to be performed in a predetermined order or any other order different from the predetermined order without disrupting the integrity of the activity, as described in further detail herein.

Electronic devices are described herein that can include any suitable combination of components configured to perform any number of tasks. Components, modules, elements, etc. of the electronic devices can refer to any assembly, subassembly, and/or set of operatively-coupled electrical components that can include, for example, a memory, a processor, electrical traces, optical connectors, software (executing in hardware), and/or the like. For example, an electronic device and/or a component of the electronic device can be any combination of hardware-based components and/or modules (e.g., a field-programmable gate array (FPGA), an application specific integrated circuit (ASIC), a digital signal processor (DSP)), and/or software-based components and/or modules (e.g., a module of computer code stored in memory and/or executed at the processor) capable of performing one or more specific functions associated with that component and/or otherwise tasked to that electronic device.

The embodiments described herein relate generally to image analysis, which can include analysis of a single and/or still image (e.g., a picture) or multiple images or frames that collectively form a “video stream.” A “video stream” can be sent, received, and/or analyzed as a continuous video recording or can be sent, received, and/or analyzed as any number of individual frames or still images, which collectively form the “video stream.” While references may be made herein to either an “image” or a “video,” it should be understood that such a reference is not to the exclusion of either a “video” or an “image,” respectively, unless the context clearly states otherwise. In other words, any of the apparatus, systems, and/or methods described herein can be used in or for image analysis and video analysis and reference to a specific type of analysis is not intended to be exclusive unless expressly provided.

The embodiments and methods described herein can use facial recognition analysis to identify one or more people in one or more images and/or video streams. As used herein, “facial recognition analysis”—or simply, “facial recognition”—generally involves analyzing one or more images of a person's face to determine, for example, salient features of his or her facial structure (e.g., cheekbones, chin, ears, eyes, jaw, nose, hairline, etc.) and then defining a qualitative and/or quantitative data set associated with and/or otherwise representing the salient features. One approach, for example, includes extracting data associated with salient features of a person's face and defining a data set including geometric and/or coordinate based information (e.g., a three-dimensional (3-D) analysis of facial recognition and/or facial image data). Another approach, for example, includes distilling image data into qualitative values and comparing those values to templates or the like (e.g., a two-dimensional (2-D) analysis of facial recognition and/or facial image data). In some instances, another approach can include any suitable combination of 3-D analytics and 2-D analytics.

Any of the embodiments and/or methods described herein can use and/or implement any suitable facial recognition method and/or algorithm or combination thereof. Examples of facial recognition methods and/or algorithms can include but are not limited to Principal Component Analysis using Eigenfaces (e.g., Eigenvector associated with facial recognition), Linear Discriminate Analysis, Elastic Bunch Graph Matching using the Fisherface algorithm, Hidden Markov model, Multilinear Subspace Learning using tensor representation, neuronal motivated dynamic link matching, convolutional neural networks (CNN), and/or the like or combination thereof.

In some instances, facial recognition analysis can result in a positive identification of facial image data in one or more images and/or video streams when the result of the analysis satisfies a criteria(ion). In some instances, the criteria(ion) can be associated with a minimum confidence score or level and/or matching threshold, represented in any suitable manner (e.g., a value such as a decimal, a percentage, and/or the like). For example, in some instances, the criteria(ion) can be a threshold value or the like such as a 70% match of the image data to the facial image data (e.g., stored in a database), a 75% match of the image data to the facial image data, a 80% match of the image data to the facial image data, a 85% match of the image data to the facial image data, a 90% match of the image data to the facial image data, a 95% match of the image data to the facial image data, a 97.5% match of the image data to the facial image data, a 99% match of the image data to the facial image data, or any percentage therebetween.

In some implementations, the embodiments and/or methods described herein can analyze any suitable data (e.g., contextual data) in addition to the facial image data, for example, to enhance an accuracy of the confidence level and/or level of matching resulting from the facial recognition analysis. For example, in some instances, a confidence level and/or a level of matching can be adjusted based on analyzing contextual data associated with any suitable source, activity, location, pattern, purchase, ticket sale, social media post, social media comments, social media likes, web browsing data, preference data, and/or any other suitable data. In some instances, a confidence level can be increased when the contextual data supports the result of the facial recognition analysis and can be decreased when the contextual data does not support and/or contradicts the result of the facial recognition analysis. Accordingly, non-facial recognition data can be used to corroborate the facial recognition data and/or increase/decrease a confidence score and/or level.

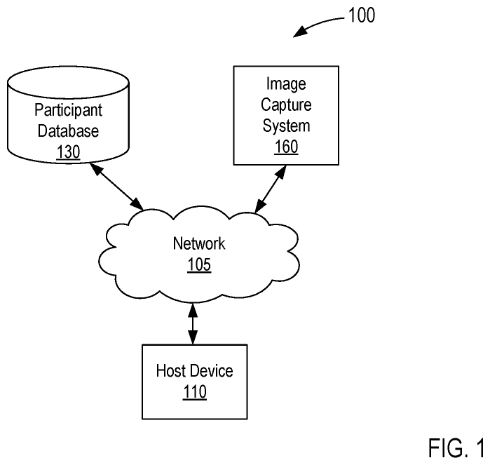

FIG. 1 is a schematic illustration of a recognition and participation management system 100 (also referred to herein as “system”) according to an embodiment. At least a portion of the system 100 can be, for example, represented and/or described by a set of instructions or code stored in a memory and executed in a processor of one or more electronic devices (e.g., a host device, a server or group of servers, a personal computer (PC), a network device, a client device, and/or the like). The system 100 includes a host device 110 that is in communication, via a network 105, with a participant database 130 participant database 130 and an image capture system 160. In some implementations, the system 100 can be configured to provide and/or perform, in substantially real-time, facial recognition analysis on at least one image (e.g., captured by the image capture system 160) of an active participant performing at least one action associated with a turn of a live, turn-based multi-participant activity. The facial recognition analysis can be performed (e.g., by the host device 110) on the at least one image with respect to facial image data included in one or more participant profile data structures (e.g., stored in the participant database 130) associated with a set of participants taking part in and/or participating in the live, turn-based multi-participant activity. The system 100 can identify the active participant as a participant from the set of participants, in response to a determination that a result of the facial recognition analysis satisfies and/or otherwise meets a predefined criterion. Having identified the participant, the system 100 can attribute, assign, and/or otherwise associate data representing one or more actions to or with the participant performing the one or more actions. In some instances, the system 100 can be configured to enable and/or allow asynchronous live participation in and/or of the live, turn-based multi-participant activity. Similarly stated, in some instances, the system 100 can enable and/or allow the set of participants to take turns in an order that can be, for example, a predetermined, initial, and/or agreed to order or that can be different from the predetermined, in initial, and/or agreed to order otherwise associated with the live, turn-based multi-participant activity.

The network 105 can be any type of network or combination of networks such as, for example, a local area network (LAN), a wireless local area network (WLAN), a virtual network (e.g., a virtual local area network (VLAN)), a wide area network (WAN) such as the Internet, a metropolitan area network (MAN), a worldwide interoperability for microwave access network (WiMAX), a telephone network (such as the Public Switched Telephone Network (PSTN) and/or a Public Land Mobile Network (PLMN)), an intranet, the Internet, an optical fiber (or fiber optic)-based network, a cellular network, and/or any other suitable network. The network 105 can be implemented as a wired and/or wireless network. By way of example, the network 105 can be implemented as a wireless local area network (WLAN) based on the Institute of Electrical and Electronics Engineers (IEEE) 802.11 standards (also known as “WiFi®”). Moreover, the network 105 can include a combination of networks of any type such as, for example, a LAN or WLAN and the Internet. In some embodiments, communication between one or more devices can be established via the network 105 and any number of intermediate networks and/or alternate networks (not shown), which can be similar to or different from the network 105. As such, data can be sent to and/or received by devices, databases, systems, etc. using multiple communication modes (e.g., associated with any suitable network(s) such as those described above) that may or may not be transmitted using a common network.

The host device 110 can be any suitable device configured to send data to and/or receive data from at least the participant database 130 and/or the image capture system 160 (e.g., via the network 105). In some implementations, the host device 110 can function as, for example, a personal computer (PC), a workstation, a server device (e.g., a web server device), a network management device, an administrator device, and/or so forth. In some implementations, the host device 110 can be any number of servers, devices, and/or machines collectively configured to perform as the host device 110. For example, the host device 110 can be a group of servers housed together in or on the same blade, rack, and/or facility or distributed in or on multiple blades, racks, and/or facilities.

In some implementations, the host device 110 can be a virtual machine, virtual private server, and/or the like that is executed and/or run as an instance or guest on a physical server or group of servers. For example, the host device 110 can be an instance that resides, or is otherwise stored, run, executed, and/or otherwise deployed in a cloud-computing environment. Such a virtual machine, virtual private server, and/or cloud-based implementation can be similar, such as in form and/or function, to a physical machine. Thus, the host device 110 can be implemented as one or more physical machine(s) or as a virtual machine hosted by or run on a physical machine. Similarly stated, the host device 110 may be configured to perform any of the processes, functions, and/or methods described herein whether implemented as a physical machine or a virtual machine.

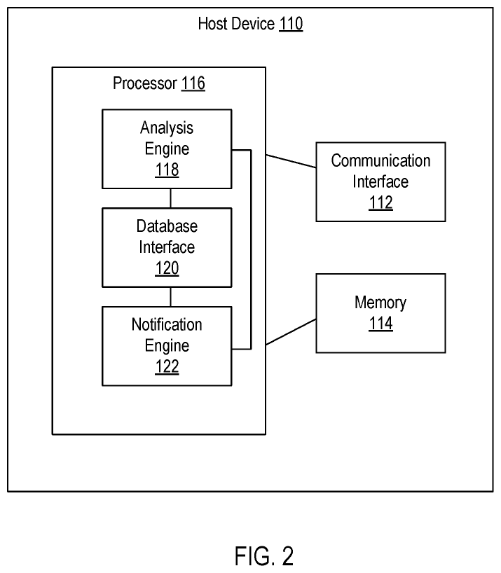

The host device 110 includes at least a communication interface 112, a memory 114, and a processor 116 (see FIG. 2). The communication interface 112, the memory 114, and the processor 116 are connected and/or electrically coupled so that signals can be sent therebetween. The host device 110 can also include and/or can otherwise be operably coupled to the participant database 130 and/or the image capture system 160, and be configured to receive, retrieve, and/or store participant and/or user data, facial recognition data, contextual data (e.g., associated with a time, location, venue, event, activity, participants in an activity, etc.), one or more images and/or image data, multimedia (e.g., video) streams, and/or the like.

The communication interface 112 can be any suitable hardware-based and/or software-based device(s) (executed by the processor 116). For example, in some implementations, the communication interface 112 can include one or more wired and/or wireless interfaces, such as, for example, network interface cards (NIC), Ethernet interfaces, optical carrier (OC) interfaces, asynchronous transfer mode (ATM) interfaces, and/or wireless interfaces (e.g., a WiFi® radio, a Bluetooth® radio, a near field communication (NFC) radio, and/or the like). As such, the communication interface 112 can be configured to send signals between the memory 114 and/or processor 116, and the network 105. In some implementations, the communication interface 112 can be configured to place the host device 110 in communication, via the network 105 with at least the participant database 130 and/or the image capture system 160. In some implementations, the communication interface 112 can further be configured to communicate, via the network 105 and/or any other network, with any other suitable device(s) and/or service(s) configured to send, receive, gather, and/or at least temporarily store data such as participant and/or user data, image data, video stream data, facial recognition data, facial image data, notification data, turn-based multi-participant activity data, and/or the like. For example, in some instances, the communication interface 112 can be configured to communicate with one or more client devices (not shown in FIG. 1) associated with one or more participants of the turn-based multi-participant activity.

The memory 114 of the host device 110 can be, for example, a random access memory (RAM), a memory buffer, a hard drive, a read-only memory (ROM), an erasable programmable read-only memory (EPROM), an electrically erasable programmable read-only memory (EEPROM), flash memory and/or any other suitable solid state non-volatile computer storage medium, and/or the like. In some instances, the memory 114 includes a set of instructions or code (e.g., executed by the processor 116) used to perform one or more actions associated with, among other things, communicating with the network 105, receiving, analyzing, and/or presenting image data, facial image data, facial recognition data, and/or any other suitable data, storing data in and/or otherwise associating data with one or more participant profile data in structures (e.g., stored in the participant database 130), and/or the like, as described in further detail herein.

The processor 116 can be any suitable processor, such as a general-purpose processor (GPP), a central processing unit (CPU), an accelerated processing unit (APU), a graphics processor unit (GPU), a network processor, a front end processor, a Field Programmable Gate Array (FPGA), an Application Specific Integrated Circuit (ASIC), and/or the like. The processor 116 can be configured to perform and/or execute a set of instructions, modules, and/or code stored in the memory 114. For example, the processor 116 can be configured to execute a set of instructions and/or modules associated with, among other things, communicating with the network 105 and/or receiving, analyzing, registering, defining, storing, and/or sending image data, facial image data, facial recognition data, participant data, activity data, contextual data, metadata, and/or any other suitable data, as described in further detail herein.

In some implementations, the processor 116 can include, for example, portions, modules, components, engines, interfaces, circuits, and the like, configured to execute and/or otherwise perform a specific and/or predefined process or task. The portions of the processor 116 can be, for example, hardware modules or components, software modules and/or components stored in the memory 114 and/or executed in the processor 116, virtual modules and/or components, and/or any combination thereof. For example, as shown in FIG. 2, the processor 116 includes and/or executes an analysis engine 118, a database interface 120, and a notification engine 122. The analysis engine 118, the database interface 120, and the notification engine 122 can be connected and/or electrically coupled (e.g., via a bus) such that signals can be communicated therebetween.

The analysis engine 118 can include, for example, a set of instructions and/or can execute a set of instructions associated with extracting, selecting, analyzing, and/or classifying objects including, for example, image data, facial image data, facial recognition data, and/or any other suitable data. The analysis engine 118 can additionally or can otherwise include and/or execute, for example, a set of instructions associated with receiving, collecting, aggregating, and/or analyzing image data, video data, participant data, facial recognition data, and/or any other suitable data associated with one or more participants, one or more images, and/or one or more video streams. For example, the analysis engine 118 can receive data from the communication interface 112, the database interface 120, the notification engine 122, and/or the like. In response, the analysis engine 118 can, for example, perform and/or execute any number of processes associated with analyzing the data, as described in further detail herein. Moreover, in some instances, the analysis engine 118 can be configured to send analyzed data to the communication interface 112, the database interface 120, the notification engine 122, and/or the like.

In some instances, the data can include, for example, data corresponding to and/or associated with one or more images of an active participant performing at least one action associated with a turn in or of a live, turn-based multi-participant activity. In some instances, the data can include, for example, data associated with the active participant, any other participant (e.g., an “inactive participant”), and/or the activity, such as facial recognition data, image data, activity data, activity participation data, activity participant data, activity logs, turn logs, play logs, profile information, preferences, location information, contact information, calendar information, social media connections, social media activity information, and/or the like. The activity can include, for example, a live, turn-based multi-player game, such as bowling, darts, etc., and/or any other games or activities at, for example, a bowling alley, pool hall, bar, golf course or driving range, arcade, arena, track, casino, and/or the like. In some instances, the data can include, for example, data associated with a venue, such as location data, resource data, event schedule, activity schedule, and the like. The data can alternatively or otherwise include any other suitable data, in accordance with embodiments of the present disclosure. In some instances, the data can include, for example, data of or associated with an activity, an event, an image, images or image frames such as in a video, and/or the like.

The database interface 120 can include a set of instructions and/or can execute a set of instructions associated with querying, parsing, monitoring, updating, retrieving, extracting, locating, and/or otherwise communicating with one or more databases such as, for example, the participant database 130. For example, the database interface 120 can include instructions to cause the processor 116 to update data stored in the participant database 130 with participant data, image data, multimedia (e.g., video, audio) stream data, facial recognition data, facial image data, notification data, participant data, participation data, turn data, multi-participant activity data, and/or the like, such as may be received by the analysis engine 118. In some implementations, the database interface 120 can be configured to define and/or update any number of participant profile data structures that can be stored, for example, in the participant database 130.

The notification engine 122 can include a set of instructions and/or can execute a set of instructions associated with defining one or more images, video streams, and/or notifications. For example, the notification engine 122 can define one or more notifications (or instructions operable to cause an electronic device to present one or more notifications) in response to instructions received, for example, from the analysis engine 118. More specifically, in some instances, the notification engine 122 can be configured to define a notification when (i) there has been a positive facial recognition identification (e.g., positive facial recognition identification event), and/or (ii) in response to the analysis engine 118 determining, generating, or defining an activity participation scheme by which to allow (1) asynchronous live participation by a set of participants in or of a live, turn-based multi-participant activity, or (2) the set of participants to take turns in an order different from a predetermined order otherwise associated with the live, turn-based multi-participant activity. After the notification is defined, the host device 110 can send to an electronic device (e.g., a client or user device) associated with a corresponding participant (e.g., the participant owning and/or using the client device 130) a signal that is indicative of an instruction to cause the electronic device to present the notification and/or an instance of the notification on the electronic device, as described in further detail herein. Moreover, in some instances, the notification and/or data included in or with the notification can include one or more portions or instances of the image data depicting an active participant performing at least one action associated with a turn in and of the live, turn-based multi-participant activity.

Returning to FIG. 1, the participant database 130 can be any suitable database such as, for example, a relational database, an object database, an object-relational database, a hierarchical database, a network database, an entity-relationship database, a structured query language (SQL) database, an extensible markup language (XML) database, a digital repository, a media library, a cloud server or storage, and/or the like. In some implementations, the participant database 130 can be and/or can include a relational database, in which data can be stored, for example, in tables, matrices, vectors, etc. according to the relational model. In some implementations, the participant database 130 is in communication with the host device 110 over one or more suitable networks (e.g., the network 105 via the communication interface 112 of the host device 110). In such implementations, the participant database 130 can be included in or stored by a network attached storage (NAS) device that can communicate with the host device 110 over the network 105 and/or any other network(s). In other embodiments, the participant database 130 can be operably coupled to the host device 110 via a cable, a bus, a server rack, and/or the like. In still other embodiments, the participant database 130 can be stored in the memory 114 of the host device 110.

The participant database 130 can store and/or at least temporarily retain data associated with the system 100. For example, in some instances, the participant database 130 can store data associated with and/or otherwise representing participant profiles, resource lists, facial recognition data, facial recognition modes and/or methods, contextual data (e.g., data associated with time, space, location, venue, event, activity, etc.), multimedia data including, for example, image data, video stream data or portions thereof, and/or the like. In some implementations, the participant database 130 can store data associated with one or more persons, or one or more participants in, of, or associated with (i) an activity such as a live, turn-based multi-participant activity, or (ii) a transaction, registration event, log-in event, identification event, etc. in or with the system 100 (e.g., “registered participants”). For example, data associated with participants can be stored in or by the participant database 130 as at least a part of a participant profile data structure, contextual data, and/or the like. In some instances, contextual data can include, for example, contextual activity data, and/or the like (e.g., data associated with time, space, location, venue, event, activity, etc.).

In some implementations, data included in the participant profile data structure can include data associated with, corresponding to, and/or representative of one or more images of a participant of or in the live, turn-based multi-participant activity. In some implementations, the data included in the participant profile data structure can alternatively or otherwise also include data associated with an active participant, a competitor, and/or one or more potential participants or competitors (e.g., bystanders, spectators) in the live, turn-based multi-participant activity. In some implementations, the data included in the participant profile data structure can alternatively or otherwise also include data associated with a participant, including, for example, one or more person(s) who (i) is known to have participated in an activity such as a live, turn-based multi-participant activity, (ii) is an active or inactive participant in a current activity, or (iii) is likely to participate in the activity.

In some implementations, the data included in the participant profile data structure can include, for example, facial image data associated with each participant from a number of participants of a live, turn-based multi-participant activity. In such implementations, the facial image data can include, for example, facial image data (and/or video stream data) associated with each participant from the number of participants, facial recognition data resulting from the host device 110 analyzing the facial image data, and/or the like. In such implementations, the facial image data can be received, for example, in, by, or via the host device 110 and from the image capture system 160, a client device (e.g., of or associated with one or more participants in the activity), and/or the like, as described in further detail herein.

The image capture system 160 can be and/or can include any suitable device or devices configured to capture image data. For example, the image capture system 160 can be and/or can include one or more cameras and/or image recording devices configured to capture an image (e.g., a photo) and/or record a video stream. In some implementations, the image capture system 160 can include multiple cameras in communication with a central computing device such as a server, a personal computer, a data storage device (e.g., a NAS device, a database, etc.), and/or the like. In such implementations, the cameras can be autonomous (e.g., can capture image data without user prompting and/or input), and can each send image data to the central computing device (e.g., via a wired or wireless connection, a port, a serial bus, a network, and/or the like), which in turn, can store the image data in a memory and/or other data storage device. Moreover, the central computing device can be in communication with the host device 110 (e.g., via the network 105) and can be configured to send at least a portion of the image data to the host device 110. Although shown in FIG. 1 as being in communication with the host device 110 via the network 105, in other embodiments, such a central computing device can be included in, a part of, and/or otherwise coupled to the host device 110. In still other embodiments, the cameras can be in communication with the host device 110 (e.g., via the network 105) without such a central computing device.

In some implementations, the image capture system 160 can be associated with and/or owned by a venue or the like such as, for example, a sports arena, a theme park, a theater, a place of business, a person's home, and/or any other suitable venue. In other implementations, the image capture system 160 can be used in or at a venue but owned by a different entity (e.g., an entity licensed and/or otherwise is authorized to use the image capture system 160 in or at the venue such as, for example, a television camera at a sporting event). In some instances, the image capture system 160 is configured to capture image data associated with an event or activity, occurring at a venue, and/or the like. Similarly stated, the image capture system 160 is configured to capture image data within a predetermined, known, and/or given context (e.g., image data of an activity or event, one or more participants in or of the activity or event, etc.). For example, in some instances, the image capture system 160 can include one or more image capture devices (e.g., cameras and/or video recorders) that are installed at a place of business in which one or more groups of people participate in one or more turn-based multi-participant activities (e.g., an arena, a bowling alley, a pool hall, a pub, a bar, and/or the like) and that are configured to capture image data associated with participants, competitors, patrons, guests, performers, spectators, observers, bystanders, etc. of the one or more turn-based multi-participant activities. In this manner, the image capture system 160 is configured to capture image data within the context of the activity, the venue and/or an event occurring at the venue, the participants (active or inactive) participating in the activity, the spectators, observers, bystanders, etc. of the activity, and/or the like. In some instances, the image capture system 160, the host device 110, and/or any other device included in the system 100 can be configured to collect, determine, define, etc. contextual data associated with the captured image data, which in turn, can be stored as contextual data, metadata, and/or the like associated with the captured image data.

An example of using the system 100 (FIG. 1) in and/or for a turn-based multi-participant activity is provided below. In some instances, the turn-based multi-participant activity can be, for example, a turn-based multi-player game that is played live and/or otherwise in a non-virtual environment. Such a game can include, for example, bowling, darts, etc., and/or any other games or activities at, for example, a bowling alley, pool hall, bar, golf course or driving range, arcade, arena, track, casino, and/or the like. In other instances, the activity can be any suitable multi-participant game or non-game activity (or any game or activity capable of being multi-participant). While some multi-participant activities are listed above, it should be understood that the list is not exhaustive and is provided by way of example only and not limitation. Other multi-participant activities, multi-player games, and/or the like are similarly contemplated within the scope of the disclosure.

In some instances, participating the in the turn-based multi-participant activity can include an initial registration, association, identification, log-in, etc. (referred to for simplicity as “registration”) of the participants of the activity. For example, the registration can include defining a participant profile data structure associated with each participant of the activity. In some instances, the registration can include receiving facial image data associated with each participant which can be stored in and/or otherwise associated with the participant profile data structure for that participant. In some instances, the system 100 (e.g., the analysis engine 118 of the host device 110) can perform any suitable facial recognition process and/or algorithm (e.g., such as any of those described above) to analyze facial image data of each participant as part of the initial registering of the participant. In some instances, the host device 110 can use the facial image data and/or any data associated with and/or during the registration as a template and/or data set against which data included in one or more images received from the image capture system 160 is compared, as described herein.

In some instances, the image capture system 160 can be used to capture the facial image data of each participant for use in the registration. In other instances, the system 100 and/or the host device 110 can receive one or more images and/or video streams from one or more electronic devices that are placed, at least temporarily, in communication with the host device 110 via the network 105. For example, in some instances, the host device 110 can receive the facial image data used in the registration of the participants from a client device associated with at least one participant. Although not shown in FIG. 1, a client device of or associated with a participant can be any suitable device such as a PC, a laptop, a convertible laptop, a tablet, a personal digital assistant (PDA), a smartphone, a wearable electronic device (e.g., a smart watch, etc.), and/or the like.

In some implementations, such as client device can include, for example, at least a memory, a processor, and a communication interface. The memory, process, and communication interface of the client device can be any of those described above with reference to the memory 114, the processor 116, and the communication interface 112, respectively, of the host device 110 and therefore, are not described in further detail herein. In addition, the client device can include at least an output device and an input device. The output device can be any suitable device configured to provide an output resulting from one or more processes being performed on or by the client device. For example, in some implementations, the output device can be any suitable display that can visually, graphically, or otherwise perceptibly represent data and/or a graphical user interface (GUI) associated with a webpage, PC application, mobile application, and/or the like. In some implementations, such a display can be and/or can include a touch screen configured to receive a tactile and/or haptic user input. The input device can be any suitable module, component, and/or device that can receive and/or capture one or more inputs (e.g., user inputs). For example, a touch screen or the like of a display (e.g., the output device) can be an input device configured to receive a tactile and/or haptic user input. In some implementations, an input device can be a camera and/or other imaging device capable of capturing images and/or recording videos (referred to generally as a “camera”). In some embodiments, such a camera can be forward or rearward facing camera integrated into a client device of a user (e.g., as in smartphones, tablets, laptops, etc.) and/or can be any other suitable camera integrated into and/or in communication with the client device.

As such, in some instances, a user can manipulate the client device and/or a PC or mobile application being executed on the client device to establish and/or register one or more participant accounts and/or profiles with the system 100. For example, a participant can manipulate the client device (e.g., owned, used, and/or otherwise associated with that participant) to cause the camera to generate and/or capture image data (e.g., a picture or a video). In some instances, the client device can be a smartphone, tablet, and/or wearable electronic device that the participant can manipulate to cause a forward facing camera to take a picture or video of at least himself or herself (e.g., also known as a “selfie”), which can then be sent to the host device 110 via the network 105. Similarly, each participant can capture a selfie and can send the image data to the host device 110 via the network 105. In other instances, an image capturing the face of more than one participant can be used to register each participant shown in the image. For example, the image capture system 160 and/or a client device of at least one participant can capture a group photo and/or image of at least some of the participants of the activity.

In some instances, the host device 110 can receive the image data (e.g., via the network 105 and the communication interface 112). Upon receipt, the analysis engine 118 can execute a set of instructions or code (e.g., stored in the analysis engine 118 and/or in the memory 114) associated with extracting, selecting, and classifying objects in, of, or including, for example, aggregating, analyzing, sorting, updating, parsing, and/or otherwise processing the image data.

In some instances, the host device 110 can also receive any suitable contextual data, metadata, and/or any of suitable data associated with each participant in addition to the image data. In some instances, the analysis engine 118 can aggregate the data associated with each participant into an initial data set (e.g., a registration data set, a log-in data set, and/or the like) and can define a participant profile data structure and/or the like that includes, for example, the initial data set and/or any other suitable information or data. After defining the initial data set, the analysis engine 118 can send a signal to, for example, the database interface 120 indicative of an instruction to store the participant profile data structures including the initial data set in the participant database 130. In some instances, the host device 110 can send a confirmation to, for example, the client device associated with each participant and/or the client device used to provide the facial image data after the initial data set is stored in the participant database 130 (e.g., after the participant and/or participants is/are registered with the system 100). In addition, any of the participant profile data and/or any portion of the initial data set can stored on the client device associated with that participant profile.

In some instances, after the registration and/or logging-in of each participant, the host device 110 can—automatically or in response to an input received from one or more of the participants—determine, define, and/or otherwise assign a predetermined and/or initial order of turns for each participant. In an example in which the activity is bowling, initial order of turns can indicate which participant is first to bowl, which participant is second to bowl, which participant is third to bowl, and so on. In some instances, the predetermined and/or initial order of turns can be an order agreed upon by the participants. As described in further detail herein, in other instances, the host device 110 need not determine, define, and/or otherwise assign the predetermined and/or initial order.

After registration of the participants, the activity can begin and/or can progress by a participant performing one or more actions associated with the activity and/or associated with the participant's turn. In this context, the participant performing the one or more actions can be, for example, an active participant while the other participants are each inactive participants. In some instances, the host device 110 and more particularly, the communication interface 112 (see FIG. 2) can receive image data (or video stream data) from the image capture system 160 either directly or indirectly, as described above. The image data can be and/or can include at least one image of the active participant performing the one or more actions. In some instances, the image data can be and/or can include video data including any number of image frames that can, for example, depict the active participant performing the one or more actions.

In some implementations, the analysis engine 118 can be configured to analyze and/or process the image data. In some instances, the analysis engine 118 can be configured to perform facial recognition analysis on the image data using any of the methods and/or techniques described herein. In addition, the analysis engine 118 can be configured to receive, analyze, and/or determine any other information and/or data associated with the image data (e.g., contextual data, metadata, etc.). For example, in some instances, contextual information and/or data can include, for example, activity data, participant data, location data, venue data, time data, coinciding event data, data associated with a round or rounds of the activity, data indicating a participant's turn, and/or any other suitable contextual information. In some instances, the analysis engine 118 can be configured to extract, select, classify, match, aggregate, and/or otherwise associate objects in, of, or including, for example, at least a portion of the image data to the contextual data.

In some instances, the analysis engine 118 can be configured to analyze the image data and/or the contextual data relative to data, for example, in each participant profile data structure stored in the participant database 130. In general, the analysis engine 118 can be configured to determine whether any data associated with the participant and/or a client device associated with the participant that is stored in the participant profile data structure satisfies one or more criteria(ion) with respect to the image data and/or the contextual data. In some instances, the criteria(ion) can be associated with a desired level of confidence in identifying the active participant as one of the participants registered and/or otherwise participating in the activity.

By way of example, in some instances, the analysis engine 118 can analyze the image data and/or the contextual data with respect to the data stored in each participant profile data structure to determine whether the participant associated with that participant profile data structure is the active participant shown in the image data. In such instances, the analysis engine 118 can be configured to perform a facial recognition analysis on the image data with respect to facial image data stored in one or more participant profile data structures. If the analysis engine 118 identifies the active participant shown in the image data as the participant associated with a particular participant profile data structure with a desired level of confidence (e.g., a confidence level above a threshold level as described above), the host device 110 can define, save, and/or register an indication that the participant is the active participant. In some instances, the analysis engine 118 can be configured to store in the participant profile data structure any suitable data representing and/or associated with the confidence level and/or data representing and/or associated with the indication that the participant is the active participant.

In response to the analysis engine 118 determining that the participant is the active participant, the host device 110 can be configured to define, save, record, and/or register any suitable data associated with and/or at least partially representing the one or more actions performed by the active participant and/or a result or set of results generated by the one or more actions performed by the active participant. The data associated with and/or resulting from the one or more actions performed by the active participant can be based at least in part on the turn-based multi-participant activity. For example, in some instances, the data can be a resulting score, number, grade, measure of effectiveness, measure of efficiency, measure of completion, measure of time associated with the active participant's action(s), and/or any other suitable data.

By way of example, the activity can be, for example, a game of bowling in which four participants (Participant A, Participant B, Participant C, and participant D) are bowling using one bowling lane. In some instances, the host device 110 can receive image data including at least one image of an active participant taking his or her turn to bowl. As described above, the host device 110 (e.g., the analysis engine 118) can perform facial recognition analysis on the image data with respect to facial image data stored in at least one participant profile data structure. In this example, based on the facial recognition analysis, the host device 110 can identify the active participant as Participant C. In addition to receiving the image data, the host device 110 can also receive any suitable data associated with and/or generated by the one or more actions performed by Participant C during his or her turn. For example, the host device 110 can receive data and/or can define data that is indicative of the number of pins that Participant C knocked down during his or her turn (e.g., seven pins on the first roll and three pins on the second roll). As such, the host device 110 (e.g., the analysis engine 118) can define the data indicative of the one or more actions performed by Participant C and/or the result of the one or more actions performed by Participant C and the database interface 120 can perform one or more processes and/or actions to store the data in the participant profile data structure associated with Participant C.

Although not shown in FIGS. 1 and 2, in some embodiments, the host device 110 can include and/or can be in communication with an output device such as, for example, a display or other graphic user interface. In some instances, after defining the data associated with the one or more actions performed by the active participant the host device 110 and/or any suitable portion of the processor 116 can send a signal to the output device that is indicative of an instruction to graphically represent the data associated with the one or more actions performed by the active participant. Thus, in the bowling example described above, the processor 116 can send to the output device a signal that is indicative of an instruction to graphically represent the result of participant C's turn (e.g., that he or she knocked down seven pins on the first roll and three pins on the second roll).

In some instances, the host device 110 can be configured to determine when the active participant is done with his or her turn and when a new participant becomes the active participant. That is to say, the host device 110 can determine when the active participant changes from a first participant to a second participant. In addition, the host device 110, via the communication interface 112 and the network 105, can receive image data associated with one or more actions performed by the active participant. In a process similar to that described above, the analysis engine 118 can perform facial recognition analysis on the image data with respect to facial image data included in at least one participant profile data structure to identify the active participant.

As described above, in some instances, after registering the participants of the activity, the system 100 and/or host device 110 can determine, define, and/or otherwise assign a predetermined and/or initial order of turns for each participant. In some implementations, the host device 110 and/or the analysis engine 118 can be configured to use the initial order of turns to determine, for example, which participant profile data structure to start with during the facial recognition analysis. In some instances, this can result in shorter processing times by minimizing the number of analysis iterations. In the bowling example described above, the host device may determine, define, and/or otherwise assign the predetermined and/or initial order of turns as Participant A being first, Participant B being second, Participant C being third, and Participant D being fourth. Thus, after defining and storing the data associated with the one or more actions performed by Participant C, the host device 110 and/or the analysis engine 118 can determine that, according to the initial order, Participant D should be the active participant. Accordingly, the analysis engine 118 can perform facial recognition analysis on the image with respect to the facial image data stored in the participant profile data structures starting with the participant profile data structure associated with Participant D. In instances in which the participants A-D have followed the initial order, the facial recognition analysis performed by the analysis engine 118 will result in the active participant being Participant D and thus, the analysis engine 118 does not need to perform the facial recognition analysis with respect to any other participant profile data structures.

As described above, however, in some instances, identifying which participant is the active participant using facial recognition analysis and defining and storing data associated with one or more actions performed by the active participant during his or her turn can enable and/or allow asynchronous live participation by the participants in the activity. Similarly stated, the system 100 can enable and/or allow the order in which each participant performs one or more actions associated with his or her turn to be changed from a predetermined and/or initial order other agreed to and/or otherwise expected. Referring again to the bowling example described above, the host device 110 may determine, define, and/or otherwise assign the predetermined and/or initial order of turns as Participant A being first, Participant B being second, Participant C being third, and Participant D being fourth. Thus, after defining and storing the data associated with the one or more actions performed by Participant C, the host device 110 and/or the analysis engine 118 can determine that, according to the initial order, Participant D should be the active participant. In some instances, however, Participant D may not be available to perform one or more actions associated with his or her turn and/or may otherwise allow a different participant to take that participant's turn rather than Participant D taking his or her turn.

For example, Participant B may begin to perform one or more actions associated with his or her turn. As such, the analysis engine 118 can perform facial recognition analysis on the image with respect to the facial image data stored in the participant profile data structures starting with the participant profile data structure associated with Participant D. Because Participant D is not the active participant, the analysis engine 118 can continue to perform facial recognition analysis on the image data with respect to the participant profile data structures until the analysis engine 118 determines that Participant B is the active participant. The host device 110 (e.g., the analysis engine 118) can define data indicative of the one or more actions performed by Participant B and/or the result of the one or more actions performed by Participant B and the database interface 120 can perform one or more processes and/or actions to store the data in the participant profile data structure associated with participant B. Accordingly, the system 100 can be configured to identify the active participant and can define and store data associated with one or more actions performed by the active participant regardless of whether the participants follow the predetermined and/or initial order.

As described above with reference to FIG. 2, the processor 116 includes a notification engine 122 that can be configured to define a notification and to send the notification (or an instance of the notification) to one or more electronic device in communication with the network 105. In some instances, for example, the notification engine 122 can define a notification that is indicative of an opportunity to take a turn in the activity, in response to determining that a certain amount of time has elapsed since the preceding participant's turn and/or when the duration of the active participant's turn has exceeded a predetermined threshold. For example, in some instances, the notification engine 122 and/or any other suitable portion of the host device 110 can define and send to one or more client devices (e.g., a client device associated with each participant) a notification indicative of an opportunity to allow the set of participants to take turns in an order different from a predetermined order otherwise associated with the live, turn-based multi-participant activity. In some instances, the predetermined threshold associated with the active participant's turn can be agreed to during, as a part of, and/or after the registration of the participants.

In some instances, the notification engine 122 can define a notification to present to the anticipated active participant that provides notification that he or she is that active participant and that the preceding participant, for example, has completed the one or more actions associated with his or her turn. In addition or as an alternative, the notification engine 122 can define a notification to present to the anticipated active participant that represents a request to authorize the activity to progress in an order different than the initial order. Said another way, the notification engine 122 can define and can send (e.g., via the communication interface 112 and the network 105) a notification and/or a request that allows for asynchronous participation in the activity.

Referring again to the bowling example, after Participant C performs the one or more actions associated with his or her turn and prior to Participant D performing an action as, for example, the active participant, the host device 110 (e.g., the analysis engine 118 and/or the notification engine 122) can monitor an amount of time that has elapsed since Participant C performed and action associated with his or her turn. In some instances, if the time exceeds a threshold amount of time, the notification engine 122 can define a notification—to be sent to, for example, a client device associated with Participant D—that represents a request to authorize asynchronous participation in the activity. As such, Participant D can manipulate the client device such that the client device sends a response to the host device 110 (e.g., via the network 105) indicative of an authorization of the request or a denial of the request.

In some instances, for example, if Participant D authorizes the request for asynchronous participation, Participant B can become the active participant (as described in the example above). In other instances, authorizing the request for asynchronous participation can be such that Participant A would become the active participant. That is to say, the authorization of the request can advance the position in the order of turns without changing the order. In still other instances, the notification engine 122 can be configured to define a notification—to be sent to, for example, a client device associated with each of Participant A, Participant B, and Participant C—that an opportunity to allow any one of the Participants A, B, or C to become the active participant.

The notification engine 122 can be configured to send one or more notifications and/or an instance of one or more notifications via any suitable modality. For example, in some instances, the notification engine 122 can send a notification and/or an instance of the notification via e-mail, short message service (SMS), multimedia message service (MMS), NFC and/or Bluetooth® communication, posted to a social media platform (e.g., posted to and/or presented by Facebook, Twitter, Instagram, etc.) and/or as a notification with a native application associated with the social media platform, and/or the like. In some instances, the modality for sending the notification can be based on a user preference set, for example, during registration and/or any time thereafter.

In other implementations, the notification engine 122 can be configured to send to an output device of the host device 110 an instruction to output data, sounds, signals, and/or the like associated with one or more notifications. For example, the output device can be a display and the notification engine 122 can be configured to send to the display an instruction to graphically represent data associated with the notification on the display. As another example, an output device can be a speaker system, intercom system, loudspeaker, etc. (referred to for simplicity as “speaker system”) and the notification can be configured to send to the speaker system an instruction to output one or more audible sounds, tones, words, phrases, etc. associated with and/or otherwise conveying the one or more notifications.

As described above, the signal sent to the client device of a participant can be indicative of and/or can include data that is indicative of an instruction to cause the client device to present the notification and/or an instance of the notification via, for example, the output device. In some instances, the notification and/or data included in or with the notification can include one or more portions or instances of the image data, including, for example, facial image data associated with each participant from a number of participants of a live, turn-based multi-participant activity. In other instances, the notification need not included image data.

Although the analysis engine 118, the database interface 120, and the notification engine 122 are described above as being stored and/or executed in the host device 110, in other embodiments, any of the engines, modules, components, and/or the like can be stored and/or executed in, for example, the client device of a participant and/or the image capture system 160. For example, in some embodiments, the client device of a participant can include, define, and/or store at least a portion of a notification engine (e.g., as a native application). The notification engine can be substantially similar to or the same as the notification engine 122 of the host device 110. In some such implementations, the notification engine of the client device can replace at least a portion of the function of the notification engine 122 otherwise included and/or executed in the host device 110. Thus, the notification engine of the client device can receive, for example, data associated with the one or more actions performed by the active participant and/or the like.

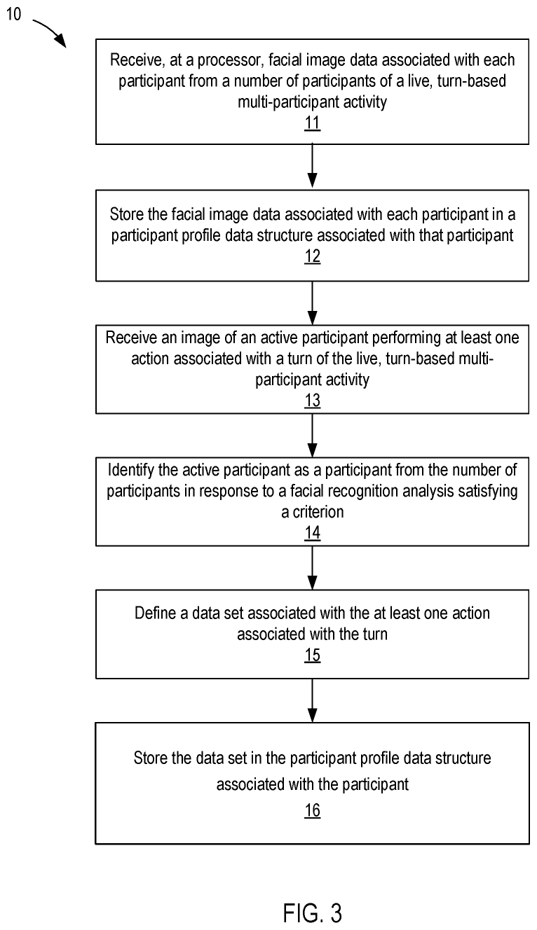

FIG. 3 is a flowchart illustrating a method 10 of using a recognition and participation management system according to an embodiment. The recognition and participation management system (also referred to herein as “system”) can be any suitable system such as, for example, the system 100 described above. As such, the system can be configured to perform, in substantially real-time, facial recognition analysis on one or more images of an active participant performing at least one action associated with a turn of a turn-based multi-participant activity. In some instances, for example, the turn-based multi-participant activity can be a live and/or non-virtual turn-based multi-participant game such as bowling, darts, and/or the like.

At 11, the method 10 can include receiving, at a processor of a host device, facial image data that is associated with each participant from a number of participants of the live, turn-based multi-participant activity. The facial image data can be received from, for example, an image capture device included in the system or from one or more client devices in communication with the host device via a network (e.g., at least one client device such as a smartphone associated with at least one of the number of participants). At 12, the method 10 can include storing the facial image data associated with each participant from the number of participants in a participant profile data structure associated with that participant from the number of participants. The participant profile data structure associated with each participant from the number of participants can be stored, for example, in a memory of the host device. In other implementations, the participant profile data structure associated with each participant can be stored, for example, in a participant database that is in communication with the host device via a wired or wireless connection. In still other embodiments, the participant profile data structure associated with each participant can be stored, for example, in the participant database, which in turn, is stored in and/or a part of the memory of the host device.

At 13, the method 10 can include receiving at least one image of an active participant performing at least one action associated with a turn of the live, turn-based multi-participant activity. In some implementations, for example, the at least one image can be captured by an image capture system and/or device of the system. In some implementations, the image capture system can be in communication with the host device either directly or indirectly. In other implementations, the image capture system can be incorporated into and/or otherwise a part of the host device.

At 14, the method 10 can include identifying the active participant shown in the at least one image as a participant from the number of participants in response to a facial recognition analysis of the at least one image with respect to the facial image data stored in the participant profile data structure associated with the participant from the number of participants satisfying a criterion. The facial recognition analysis can be performed using any of the methods described herein. In some instances, the criterion can be, for example, a threshold confidence level associated with a likelihood of a positive identification or classification of the active participant as a participant from the number of participants. In other words, in some instances, the threshold confidence level can be a minimum degree of certainty associated with a correct match as a result of the facial recognition analysis. For example, in some instances, a threshold confidence level can be 50%, 60%, 70%, 80%, 90%, 95%, 99%, and/or any other suitable confidence level. In some implementations, the threshold confidence level can be defined by the user and/or can otherwise be based on a user preference. In other implementations, the threshold confidence level can be predetermined (e.g., by the host device).

At 15, the method can include defining a data set associated with the at least one action associated with the turn. Similarly state, the data set can be associated with the at least one action performed, for example, by the active participant during the active participant's turn. As described above with reference to the system 100, the data set associated with the at least one action can be any suitable data associated with the action(s) and/or can be data representing and/or otherwise being associated with a result of the action(s). At 16, the method can include storing the data set in the participant profile data structure associated with the participant. In some instances, the method 10 can be such that identifying the active participant via facial recognition analysis (at 14), define the data set associated with the at least one action (at 15), and the storing of the data set in the participant profile data structure associated with the identified active participant can enable and/or allow asynchronous live participation in and/or of the live, turn-based multi-participant activity. Similarly stated, the method 10 can, in some instances, enable and/or allow the set of participants to take turns in an order that can be, for example, a predetermined, initial, and/or agreed to order or that can be different from the predetermined, in initial, and/or agreed to order otherwise associated with the live, turn-based multi-participant activity.

While various embodiments have been described above, it should be understood that they have been presented by way of example only, and not limitation. While specific examples have been particularly described above, the embodiments and methods described herein can be used in any suitable manner. For example, while the system 100 is described above as performing facial recognition analysis on one or more images and/or video streams, in other implementations, a host device can be configured to any suitable source of audio to identify a user at a venue and/or one or more people connected to the user. In some instances, audio or voice analysis can be performed in addition to the facial recognition analysis described herein. In other instances, audio or voice analysis can be performed instead of or as an alternative to the facial recognition analysis described herein.

[75] While the embodiments have been particularly shown and described, it will be understood that various changes in form and details may be made. Although various embodiments have been described as having particular features and/or combinations of components, other embodiments are possible having a combination of any features and/or components from any of embodiments as discussed above.

[76] Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above

While specific methods of facial recognition have been described above according to specific embodiments, in some instances, any of the methods of facial recognition can be combined, augmented, enhanced, and/or otherwise collectively performed on a set of facial recognition data. For example, in some instances, a method of facial recognition can include analyzing facial recognition data using Eigenvectors, Eigenfaces, and/or other 2-D analysis, as well as any suitable 3-D analysis such as, for example, 3-D reconstruction of multiple 2-D images. In some instances, the use of a 2-D analysis method and a 3-D analysis method can, for example, yield more accurate results with less load on resources (e.g., processing devices) than would otherwise result from only a 3-D analysis or only a 2-D analysis. In some instances, facial recognition can be performed via convolutional neural networks (CNN) and/or via CNN in combination with any suitable 2-D analysis methods and/or 3-D analysis methods. Moreover, the use of multiple analysis methods can be used, for example, for redundancy, error checking, load balancing, and/or the like. In some instances, the use of multiple analysis methods can allow a system to selectively analyze a facial recognition data set based at least in part on specific data included therein.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, FORTRAN, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A system, comprising:
a memory; and
a processor in communication with the memory, the processor configured to receive facial image data associated with each participant from a plurality of participants of a live, turn-based multi-participant activity, the facial image data associated with each participant from the plurality of participants being stored, in the memory, in a participant profile data structure associated with that participant, the processor configured to:
receive at least one image of an active participant performing at least one action associated with a turn of the live, turn-based multi-participant activity,
perform facial recognition analysis on the at least one image with respect to the facial image data stored in the participant profile data structure associated with each participant from the plurality of participants,
identify the active participant as a participant from the plurality of participants when the facial recognition analysis with respect to the facial image data associated with the participant from the plurality of participants satisfies a criterion, and
define a data set associated with the at least one action and to store the data set in the participant profile data structure associated with the participant.

2. The system of claim 1, wherein the facial recognition analysis includes defining an analyzed data set associated with the facial recognition analysis of the at least one image and comparing the analyzed data set to the facial image data stored in the participant profile data structure associated with each participant from the plurality of participants.

3. The system of claim 1, wherein the live, turn-based multi-participant activity is bowling.

4. The system of claim 1, wherein the live, turn-based multi-participant activity includes each participant from the plurality of participants taking turns in a predetermined order.

5. The system of claim 1, wherein the processor identifying the active participant as the participant from the plurality of participants and storing the data set in the participant profile data structure associated with the participant from the plurality of participants allows the plurality of participants to take turns in an order different from a predetermined order otherwise associated with the live, turn-based multi-participant activity.

6. The system of claim 1, wherein the criterion is a matching threshold associated with the facial recognition analysis.

7. A method, comprising:
receiving facial image data at a processor, the facial image data being associated with each participant from a plurality of participants of a live, turn-based multi-participant activity;
storing the facial image data associated with each participant from the plurality of participants in a participant profile data structure associated with that participant from the plurality of participants, the participant profile data structure associated with each participant from the plurality of participants being stored in a memory;
receiving at least one image of an active participant performing at least one action associated with a turn of the live, turn-based multi-participant activity;
identifying the active participant as a participant from the plurality of participants in response to a facial recognition analysis of the at least one image with respect to the facial image data stored in the participant profile data structure associated with the participant from the plurality of participants satisfying a criterion;
defining a data set associated with the at least one action associated with the turn; and
storing the data set in the participant profile data structure associated with the participant.

8. The method of claim 7, wherein the identifying the active participant includes:
defining an analyzed data set associated with the facial recognition analysis of the at least one image; and
comparing the analyzed data set to the facial image data stored in the participant profile data structure associated with at least one participant from the plurality of participants.

9. The method of claim 7, wherein the live, turn-based multi-participant activity is bowling.

10. The method of claim 7, wherein the live, turn-based multi-participant activity includes each participant from the plurality of participants taking turns in a predetermined order.

11. The method of claim 7, wherein the identifying the active participant as the participant from the plurality of participants and the storing the data set in the participant profile data structure associated with the participant allows asynchronous live participation of the live, turn-based multi-participant activity.
